(19) United States
(12) Patent Application Publication
(10) Pub. No.: US 2026/0181467 A1
(43) Pub. Date: Jun. 25, 2026

(54) METHODS, APPARATUSES, AND SYSTEMS FOR DYNAMIC QUALITY OF SERVICE ADAPTATION

(71) Applicant: InterDigital Patent Holdings, Inc., Wilmington, DE (US)

(72) Inventors: Francois Periard, Montreal (CA); Ghyslain Pelletier, Montreal (CA); Patrice Hirtzlin, Betton (FR); Faris Alfarhan, Montreal (CA); Mario Hudon, Brossard (CA); Loic Fontaine, noyal sur vilaine (FR); Stephane Onno, Saint Gregoire (FR); Etienne Faivre d'Arcier, Saint Gonlay (FR)

(21) Appl. No.: 18/991,053

(22) Filed: Dec. 20, 2024

(51) Int. Cl. H04W 28/02

(52) U.S. Cl. CPC H04W 28/0268

(57) ABSTRACT

Procedures, methods, apparatuses, systems, devices, and computer program products are provided for achieving dynamic quality of service (QoS) adaptation. Wireless transmit/receive unit (WTRU) methods and systems include storing configuration information indicating a plurality of QoS index values (QIDs) each associated with a set of QoS parameters. The methods and systems further include receiving a data unit and selecting a QID of the plurality of QIDs for the data unit based on an association between data units or a data flow corresponding to the data unit. The methods and systems further include transmitting the data unit to a wireless network based on the set of QoS parameters associated with the selected QID.

### TECHNICAL FIELD

The present disclosure is generally directed to the fields of communications, software and encoding, including, for example, to methods, apparatuses, systems related to quality of service (QoS) adaptation for data unit transmission.

### BACKGROUND

The user plane interface for telecommunication systems was designed to meet best effort data with a minimum and guaranteed bit rate requirement. However, the user plane interface does not enable flexible adjustment of QoS levels. This presents challenges, for example, for managing data flows having varying characteristics over short periods of time.

### SUMMARY

A wireless transmit/receive unit (WTRU) may be configured to transmit and/or receive data units. For example, a WTRU may transmit data units (e.g., to a wireless network) based on a set of configured QoS parameters. However, it may be desired to change the set of QoS parameters for a given data unit over time, across different data flows, and in response to certain triggers and conditions. For example, a WTRU may receive a data unit with varying bitrate over a short period of time (e.g., due to inconsistent traffic patterns) or data units with multiple flows that require synchronized delivery. In accordance with certain embodiments of this disclosure, the WTRU stores multiple indexed sets of QoS parameters, enabling the WTRU to dynamically adjust QoS parameters for data units based on a variety of inputs. Based on the systems and methods of this disclosure, more efficient data unit prioritization and resource utilization at the WTRU may be achieved while maintaining quality of experience (QoE) goals and/or requirements.

In accordance with certain embodiments of the present disclosure, methods and systems are provided for using a WTRU to dynamically adjust QoS parameters. In some embodiments, the methods include storing configuration information indicating a plurality of quality of service index values (QIDs), wherein each QID is associated with a set of QoS parameters. The methods also include receiving a data unit. The methods additionally include selecting a QID of the plurality of QIDs for the data unit. The methods further include transmitting to a wireless network, the data unit based on the set of QoS parameters associated with the selected QID.

In some embodiments, the selecting the QID includes associating a data treatment flow identification (DTFID) to the data unit and selecting the QID of the plurality of QIDs for the data unit based on the associated DTFID. In some embodiments, associating the DTFID to the data unit includes one of: identifying a QFID corresponding to the data unit, performing classification of the data unit based on a classification function, or identifying an information marking of a protocol data unit (PDU) corresponding to the data unit. In some embodiments, receiving the data unit includes receiving a plurality of data units and associating the DTFID to the data unit includes associating the DTFID to interdependent data units of the plurality of data units. In some embodiments, the set of QoS parameters associated with the selected QID includes at least one of a synchronization window, a reliability requirement, traffic type, or periodicity.

In some embodiments, the selecting the QID includes identifying a data flow identifier (QFID) corresponding to the data unit and selecting the QID of the plurality of QIDs for the data unit based on the identified QFID. In some embodiments, selecting the QID of the plurality of QIDs for the data unit based on the identified QFID includes receiving an indication from a higher layer or application programming interface of a target QID for the identified QFID, and selecting the QID of the plurality of QIDs based on the target QID. In some embodiments, the target QID includes a relative target QID. In some embodiments, selecting the QID of the plurality of QIDs based on the target QID includes identifying a current QID for the identified QFID, and selecting the QID of the plurality of QIDs based on adjusting the current QID by the relative target QID.

In some embodiments, transmitting the data unit based on the set of QoS parameters associated with the selected QID includes transmitting, to the wireless network, an indication of the selected QID. In some embodiments, transmitting the data unit based on the set of QoS parameters associated with the selected QID includes applying the set of QoS parameters associated with the selected QID to a service data unit (SDU) or a PDU corresponding to the data unit, and transmitting the SDU or PDU based on the set of QoS parameters associated with the selected QID.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A; and

FIG. 2 is a flowchart of an illustrative method performed by a WTRU for dynamic QoS adaptation, in accordance with certain embodiments of the present disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

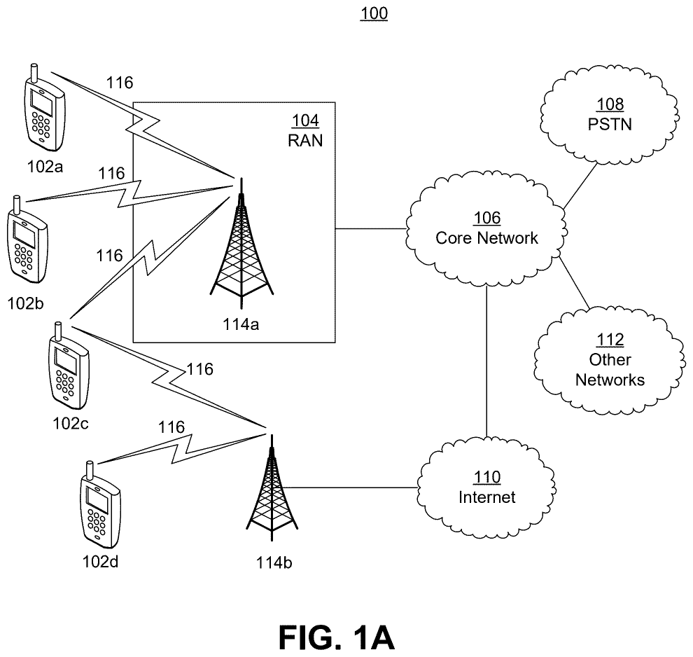

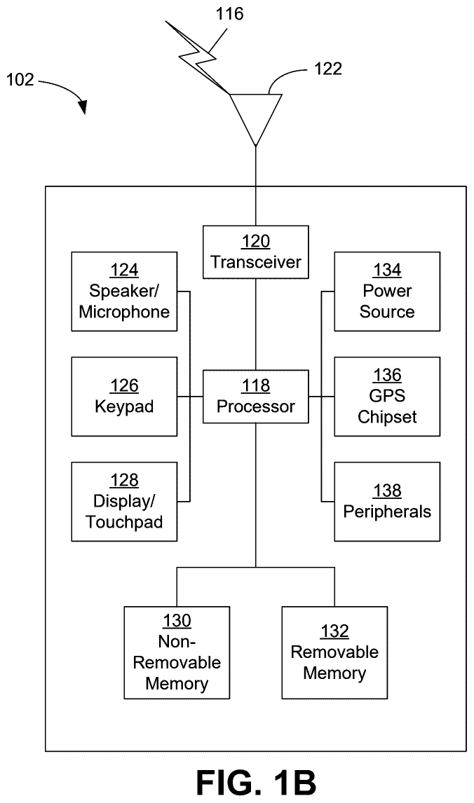

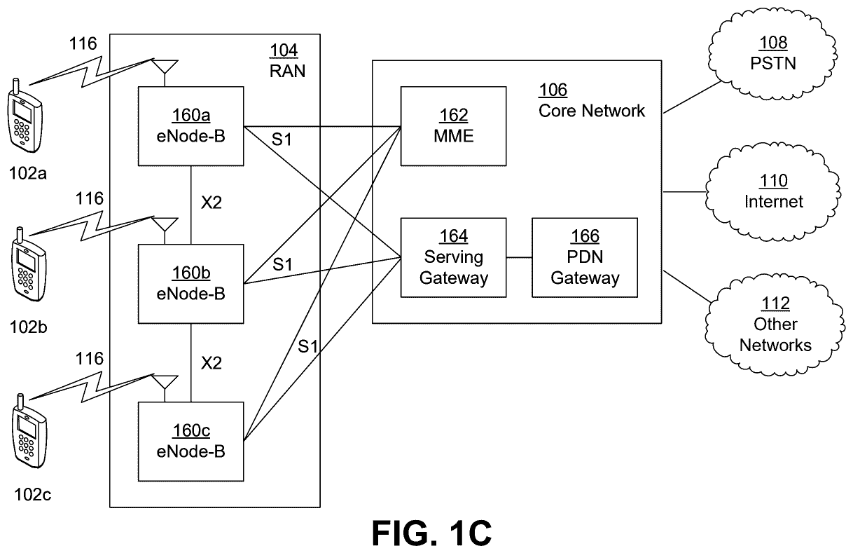

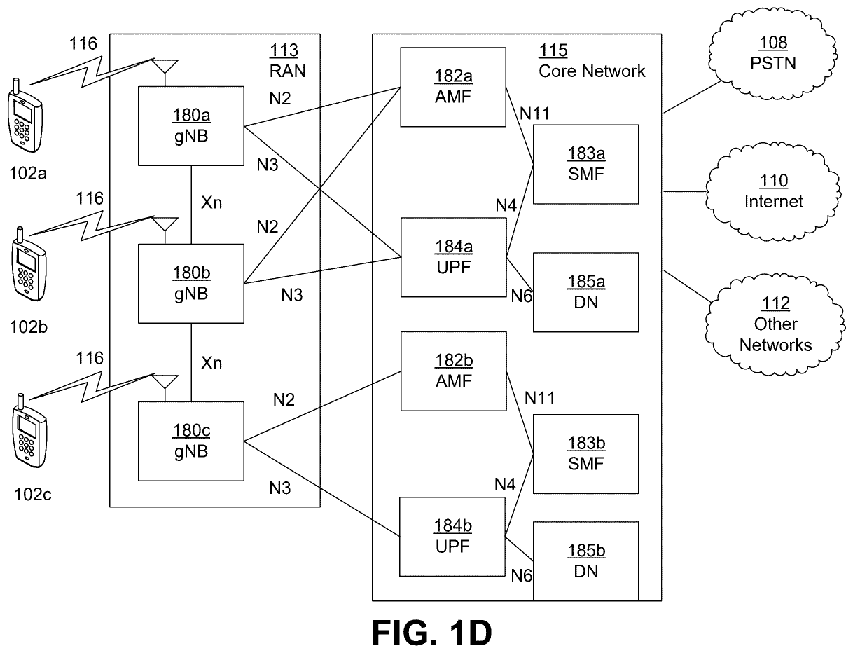

The methods, apparatuses and systems provided herein are well-suited for sensing and communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, orthogonal frequency division multiplexing (OFDM) symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

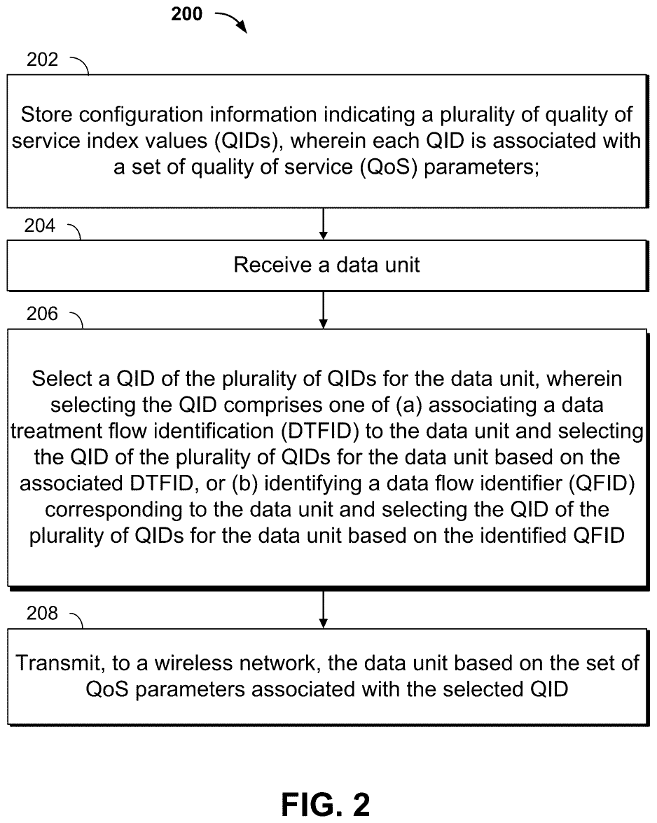

In certain embodiments of the present disclosure, including those described below at least in connection with FIG. 2, the devices, systems, communication links, apparatuses, and other elements depicted in FIGS. 1A-1D may be used in connection with dynamic QoS adaptation.

In some approaches (e.g., new radio (NR)), QoS is semi-static. For example, a user plane interface (e.g., developed for 3G and 4G) handles best effort data with a minimum and guaranteed bit rate requirement. Further, for example, the user plane interface imposes few further requirements. Moreover, for example, a new user plane interface (e.g., for layer 2 (L2) data) that improves QoS latency and reliability and additionally provides application layer awareness is desired.

For example, a L2 interface supporting variable QoS requirements, low latency, and high reliability is desired, particularly for extreme applications. Further, for example, such extreme applications may include at least one of the following: extended reality (XR), virtual reality (VR), augmented reality (AR), high-reliability low-latency communications (HRLLC), enhanced ultra-reliable low-latency communications (eURLLC), combinations of the same, or the like. Moreover, for example, QoS attributes assigned to each data unit and/or channel is desired. Additionally, for example the QoS attributes may include at least one of the following key performance indicators (KPIs): priority, prioritized bit rate (PBR), packet delay budget (PDB), packet error rate (PER), block error rate (BLER), quality of experience (QoE) level, packet delay sensitivity budget (PDSB), dependencies to other sets, strict delay, energy consumption, complexity metrics, combinations of the same or the like.

For example, a L2 interface enabling elastic varying of QoE level when QoS is met is desired. Also, for example, QoE level may correspond to a range with a lower bound of a ratio of minimum data rate to guaranteed bit rate (GBR) and an upper bound of a ratio of maximum data rate to GBR. Further, for example, QoE level may correspond to a range between minimum and maximum priorities based on latency requirement. In some examples, a minimum QoE requirement is desired. For example, a WTRU may start transmission of data with a configured QoE level and may desire to reduce the QoE level (e.g., and/or the number of data packets transmitted) based on at least one of the following: the WTRU moves out of coverage, the WTRU experiences cell congestion, the data rate drops, combinations of the same, or the like. Further, for example, if there are multiple (e.g., and/or multi-modal) streams, the WTRU may desire to drop one stream that is not necessary to meet the minimum QoE requirement while still maintaining the QoS.

For example, differentiated treatment for more important packets (e.g., based on temporal relevance or control reception relevance) is desired. Further, for example, several applications may generate packets that have different importance. In some approaches, L2 protocols have not evolved with new application layer transport protocols (e.g. quick user diagram protocol internet connection (QUIC)) developed for faster, more reliable, and more efficient data transfer. Also, for example, awareness may include radio access network (RAN) awareness of application QoS and QoE data (e.g., metrics, events, important/relevant data, or the like) and application awareness of RAN dynamic conditions (e.g. radio conditions, congestion, cell load, or the like). In one example, the application adjusts the rate of the packet set, and the WTRU may not change the underlying QoE level (e.g. when the video rate is decreased by the application). In this example, the WTRU may or may not be aware of what the application layer is adjusting (e.g., no RAN awareness of application QoS and QoE data but application awareness of RAN dynamic conditions). Additionally, for example, awareness may include awareness of at least one of the following: application flow dependencies; synchronization; sensory system data; machine learning (ML) system data; events triggered by central processing (CP) (e.g., handover); other system data; combinations of the same; or the like.

In some examples, service data flow traffic characteristics or traffic patterns may not always be constant, e.g., based on fixed bitrate, bitrate variation over a short period of time (e.g., data burst), codec performance (e.g., based on video input), application demands, or the like. For example, the application may be able to dynamically change and/or adapt the service data flow traffic requirements based on the application needs and/or end-to-end (E2E) transport measurements. In such examples, the allocation of QoS GBR may be resource intensive, not scalable, and wasteful. Likewise, for example, non-GBR QoS may not provide adaptivity (e.g., a range of acceptable data treatment). In such examples, the QoS parameters configured in the RAN per QoS flow may not support flexibility in adjusting the QoS parameters based on what the application is able to tolerate and/or its ability to adapt its service data flows.

Accordingly, application-awareness of flexible QoS parameters per data unit (e.g., PDU) and/or data flow along with association between interdependent data flows and/or SDUs and/or PDUs is proposed to enable an adaptive QoS that supports treatment of data units based on application requirements and/or dynamic RAN conditions (e.g., and maintains QoE).

In accordance with certain embodiments of the present disclosure, systems and methods are described as follows that enable a WTRU (e.g., WTRU 102 of FIGS. 1A-D) to dynamically adapt the QoS parameters applied to data units received in connection with a wireless network (e.g., RAN 104 and 113 of FIGS. 1A-D). For example, a WTRU is configured with an indexed set of QoS parameters (QID) indicating a range of supported QoS target levels (e.g., per QoS parameters and/or data flow). Further, for example, the WTRU may be configured to determine the applicable QID, perform association between SDUs and/or PDUs, and select applicable data treatment flow IDs (DTFIDs) as a function of at least one of the following: an indication from higher layers, service data unit (SDU) and/or PDU information markings, flow identifiers (QFIDs), RAN conditions, combinations of the same, or the like. In certain representative embodiments, the WTRU performs at least one of the following: receives a configuration with one or more QIDs each indicating a set of QoS parameters; performs data unit treatment processing; changes the QID value based on a trigger; receives one or more data SDUs and/or PDUs; determines applicable DTFIDs and/or QIDs for the one or more data units; performs data treatment for transmission of the one or more data units; combinations of the same; or the like.

In certain representative embodiments, the WTRU is configured (e.g., by the wireless network) with one or more QID values (e.g., index values), each corresponding to a set of QoS parameters. For example, QoS parameters may include at least one of the following: maximum flow bit rate (MFBR); aggregate maximum bit rate (AMBR); maximum data burst volume (MDBV); maximum packet loss rate; packet delay budget (PDB); packet error rate (PER); priority level; PDU set QoS parameters (e.g., PDU set delay budget (PSDB), PDU set error rate (PSER), PDU set integrated handling information (PSIHI), or the like); combinations of the same; or the like. Further, for example, the WTRU, for each QID, is configured with target levels and/or threshold levels for each QoS parameter (e.g., minimum PDB, maximum PDB, target PDB, or the like).

In certain representative embodiments, the WTRU performs SDU treatment processing steps described as follows. In some examples, the data unit treatment processing steps include determining an association between SDUs and PDUs, e.g., based on configured association information. For example, the WTRU may perform association between SDUs and/or corresponding PDUs by associating a DTFID value to each data unit based on at least one of the following: a flow identifier (QFID) corresponding to the data unit; a classification function, e.g., based on characteristics of the data unit (e.g., internet protocol (IP) 5-tuple of an IP packet SDU); data unit information markings; an indication from an application-level application programming interface (API); combinations of the same; or the like. In some examples, the WTRU determines an applicable QID for a SDU and/or PDU, data unit set (e.g., PDU set), or radio bearer. For example, the WTRU may be configured with an initial QID value to associate with a data unit. Further, for example, SDUs and/or PDUs of the same DTFID may be associated with same QID. Additionally, for example, data units of the same QFID may be associated with the same QID.

In certain representative embodiments the WTRU changes the QID value as a function of at least one of the following: a notification from a higher layer to adjust the value of the QID (e.g., indicated for a specific DTFID and/or QFID); an indication received through an application-level API; SDU and/or PDU information markings; channel measurements (e.g., a channel condition or change in channel conditions below or above a given threshold); a condition for changing the QID value of a data unit is met (e.g., priority, importance, delay bound, data type, and/or dependency to other data or control plane events); combinations of the same; or the like.

In certain representative embodiments, the WTRU receives one or more SDUs and/or PDUs, and selects the applicable DTFID and/or QID (e.g., corresponding to a set of QoS parameters) based on the configured criteria (e.g., in the configuration information received by the WTRU).

In certain representative embodiments, the WTRU applies the selected DTFID (e.g., corresponding to an association) and/or QID to the applicable data units and performs data treatment for transmission based on the selected DTFID and/or QID. In some embodiments, the WTRU sends an indication to the wireless network that includes the selected DTFID and/or QID.

In certain representative embodiments, the WTRU changes the applicable QID for one or more SDUs and/or PDUs associated with a DTFID and/or QFID to change the QoS treatment for the one or more data units, e.g., as part of an API-based or implementation-based change. For example, in connection with changing the applicable QID, the WTRU may be restricted to only changing the DTFID in at least one of the following situations: before the WTRU determines that the PDU should be multiplexed on a TB (e.g., only for TBs for which the WTRU has a valid grant); before the WTRU performs a specific processing step that may have otherwise been performed differently if the change of DTFID was applied, e.g., applying coding (e.g., linear packet coding) to the corresponding PDU; combinations of the same; or the like. Further, for example, autonomous changes in DTFID may be restricted to specific values (e.g., for changes that increase and/or decrease the DTFID and consequently overall QoS treatment), e.g., based on configuration information.

In certain representative embodiments, the WTRU sends an indication to the higher layers or the application (e.g., based on configuration information) to notify of a change in the QID (e.g., and/or DTFID) value.

Such systems and methods may enable the WTRU to dynamically change a set of QoS parameters (e.g., within configured target levels) and data treatment of SDUs and/or PDUs based on the set of QoS parameters. Furthermore, such systems and methods may enable the WTRU to consider the association between data units to enable efficient data unit prioritization and resources utilization (e.g., while maintaining QoE) when selecting and/or changing QoS parameters for the data units.

In accordance with certain representative embodiments of the present disclosure, relevant terminology is defined as follows.

In the present disclosure, a “data set” or “data unit” may be used to represent, indicate, and/or describe at least one of the following: a PDU or PDU segment (e.g., radio link control (RLC) PDU segment); one or more interdependent PDUs; one or more subsets of a PDU set; a PDU set; multiple interdependent PDU sets; a data burst, e.g., produced by the application in a short period of time, including PDUs from one or more PDU Sets; one or more PDUs related to control information (e.g., MAC control element (MAC-CE), radio resource control (RRC) signaling); one or more PDUs of system plane-related data; combinations of the same; or the like.

For example, a data set may consist of two interdependent PDUs, which may require coordinated transmission and/or reception between the two PDUs. Further, for example, the two interdependent PDUs may require to be received and/or transmitted within a synchronization window. Moreover, for example, the transmission and/or reception of the second PDU may only be useful if the first PDU was transmitted and/or received successfully. In one example, if the WTRU fails to transmit and/or receive the first PDU, transmission and/or reception of the second PDU may not be necessary and the WTRU may discard the second PDU.

For example, the WTRU may be configured to transmit a PDU set, which may consist of multiple subsets of the PDU set. Further, for example, each subset of the PDU set may be associated with one PDU importance. Additionally, or alternatively, each subset of PDU may be associated with one type of PDU in the PDU set. Also, for example, a data set may be used to describe one or more subsets of a PDU set.

For example, a data set may consist of two or more interdependent PDU sets, which may require coordinated transmission and/or reception (e.g., interdependent PDU sets in multiple interdependent QoS flows). Further, for example, the interdependent PDU sets may be received and/or transmitted within a synchronization window. Moreover, for example, the transmission and/or reception of the second PDU set may only be useful if the first PDU set was transmitted and/or received successfully. In one example, if the WTRU fails to transmit and/or receive the first PDU set, transmission and/or reception of the second PDU set may not be necessary and the WTRU may discard the second PDU set. Also, for example, a data set may be used to describe two or more interdependent PDU sets, in which the interdependent PDU sets may be from interdependent QoS flows (e.g., for multi-modality). Additionally, for example, the interdependent QoS flows may be mapped to the same and/or different data radio bearers (DRB) and/or logical channels (LCH).

For example, a data set may consist of one or more PDUs related to system data, e.g., artificial intelligence (AI)/machine learning (ML) data, sensing data, operator-provided service data, other system data, combinations of the same, or the like.

For example, a data set may include one or more PDUs related to system data for at least one of the following: computing as a service, AI/ML model as a service, other system service, combinations of the same, or the like.

In the present disclosure, “PDU-set” and “PDU set” may be used interchangeably with the “data set”.

In the present disclosure, “PDU” may describe the PDU in any of non-access stratum (NAS) layer, service data adaptation protocol (SDAP) layer, packet data convergence protocol (PDCP) layer, RLC layer, MAC layer, physical (PHY) layer, a newly defined layer, or the like.

In the present disclosure, an enhanced QoS profile may be defined to include one or many QoS configurations per data flow. For example, each QoS configuration may provide applicable QoS parameters to a particular data flow. Further, for example, applicable and/or adaptable QoS parameters may be configured through a plurality of QIDs corresponding to different data treatment levels. Moreover, for example, QoS configuration may define one or more dependent QFIDs.

For example, a QID and/or QoS associated with a data set may indicate at least one of the following: one or more parameters (e.g., QoS parameters) of a PDU and/or PDU segment associated with the data set; one or more parameters of a PDU Set (e.g., QoS parameters) associated with the data set; one or more parameters of a data burst associated with the data set; one or more redundancy parameters (e.g., application layer FEC ratio (AL-FEC ratio) associated with the data set; combinations of the same; or the like.

For example, one or more parameters (e.g., QoS parameters) of a PDU and/or PDU segment associated with the data set may include at least one of the following: flow bit rate; MFBR; PDU importance; AMBR; a priority associated with the PDU; a latency requirement of the PDU and/or PDU-segment (e.g., including PDB or remaining PDB); a synchronization window; a remaining synchronization window and/or remaining time to serve (e.g., transmit and/or receive) the PDU; a reliability requirement of the PDU (e.g., PER); a MDBV; a traffic type of PDU and/or PDU-segment (e.g., periodic vs. aperiodic); a periodicity of the PDU and/or PDU-segment; a size of the PDU and/or PDU-segment; combinations of the same; or the like.

For example, PDU importance may be used to indicate at least one of the following: the importance of the PDU set associated with the PDU, the relative importance of the PDU in the PDU set; the relative importance of the PDU in a data burst; the relative importance of the PDU in the QoS flow; combinations of the same; or the like.

For example, the synchronization window may be used to describe the synchronization requirement between two or more interdependent PDUs. Further, for example, to satisfy the QoE requirement of an XR service, the WTRU may deliver two interdependent PDUs within the synchronization window. Moreover, for example, upon transmission and/or reception of the first PDU, the WTRU may transmit and/or receive the second interdependent PDU within the synchronization window.

For example, the remaining synchronization window and/or the remaining time to serve (e.g., to transmit/receive) the PDU may be used to describe the remaining time to serve the second PDU upon transmission and/or reception of the first interdependent PDU. Further, for example, the remaining synchronization window and/or the remaining time to serve is based on a synchronization requirement between the PDU and another interdependent PDU. Moreover, for example, the WTRU may transmit and/or receive the first PDU. Additionally, for example, the WTRU may need to transmit and/or receive another interdependent PDU. Furthermore, for example, the WTRU may then initialize a timer (e.g., sync-timer) to track the synchronization between the two PDUs. Also, for example, the current value of timer (e.g., sync-Timer) may be used to indicate the remaining synchronization window and/or the remaining time to transmit and/or receive the PDU.

For example, one or more parameters of a PDU set (e.g., QoS parameters) associated with the data set may include at least one of the following: a PDU set importance (e.g., PSI, used to indicate the relative importance of a PDU set compared to other PDU sets within a QoS Flow); a PDU set priority; a synchronization window; a remaining synchronization window and/or remaining time to serve (e.g., to transmit and/or receive) the PDU set; a latency requirement associated with the PDU set; a PSIHI (e.g., indicating whether all PDUs of the PDU set are needed for the usage of PDU set by the application layer); a type of the PDU set (e.g., periodic, aperiodic); a volume of the PDU set (e.g., including a size of each PDU and/or a number of PDUs in the PDU set); a reliability requirement of a PDU set (e.g., PSER); a periodicity of the PDU set; combinations of the same; or the like.

For example, the synchronization window may be used to describe the synchronization requirement between two or more interdependent PDU sets or the synchronization requirement between one PDU set and one or more other PDUs. Further, for example, to satisfy the QoE requirement of an XR service, the WTRU may deliver two interdependent PDU sets within the synchronization window. Moreover, for example, upon transmission and/or reception of the first PDU set, the WTRU may transmit and/or receive the second interdependent PDU set within the synchronization window.

For example, the remaining synchronization window and/or the remaining time to serve (e.g., to transmit and/or receive) the PDU set may be used to describe the remaining time to serve the second PDU set upon transmission and/or reception of the first interdependent PDU set (e.g., based on a synchronization requirement between the PDU set and another interdependent PDU set). Further, for example, the WTRU may transmit and/or receive the first PDU set. Moreover, for example, the WTRU may need to transmit and/or receive another interdependent PDU set. Additionally, for example, the WTRU may initialize a timer (e.g., sync-timer) to track the synchronization between the two PDU sets. Furthermore, for example, the current value of timer (e.g., sync-timer) may be used to indicate the remaining synchronization window and/or the remaining time to transmit and/or receive the second PDU set.

For example, the latency requirement associated with the PDU set may include at least one of the following: a PSDB; a remaining PSDB; a nominal PSDB associated with the PDU set; a PDU set delivery deadline (PSDD); combinations of the same; or the like.

For example, the PSDB may be used to indicate the maximum time between reception of the first PDU (e.g., at the UPF in DL, at the WTRU in UL) and/or the successful delivery of the last arrived PDU of a PDU Set (e.g., at the WTRU in DL, at the UPF in UL). Further, for example, PSDB is an optional parameter and, if provided, the PSDB may supersede the PDB.

For example, the PSDD may be a deadline wherein the last PDU of a PDU set needs to be received at the application for the application to make use of the PDU set.

For example, the type of the PDU set, may include at least one of the following: a first type of PDU set (e.g., requiring reliable delivery of all PDUs in the set); a second type of PDU set (e.g., in which the transmission of a PDU set is unsuccessful when a particular PDU or at least one PDU fails transmission); a third type of PDU set (e.g., in which the transmission of a PDU set is successful when X PDUs of the PDU set of Y PDUs are received); combinations of the same; or the like. Further, for example, in the third type of PDU set, transmission of a PDU set may be successful when forward error correction (FEC) is used and/or when additional layered encoding is used and assigned to the same PDU set.

For example, the reliability requirement of a PDU set (e.g., PSER) may be used to indicate at least one of the following: an upper bound for the rate of PDU Sets that have been processed by the sender of a link layer protocol (e.g., RLC in RAN of a 3^{rd} generation partnership project (3GPP) access), but were not successfully delivered by the corresponding receiver to the upper layer (e.g., PDCP in RAN of a 3GPP access); an upper bound for the rate of PDUs per PDU set that have been processed by the sender of a link layer protocol (e.g., RLC in RAN of a 3GPP access), but were not successfully delivered by the corresponding receiver to the upper layer (e.g., PDCP in RAN of a 3GPP access); an upper bound for the rate of PDUs per PDU set that were not successfully received by the receiver of the upper layer (e.g., PDCP in RAN of a 3GPP access); combinations of the same; or the like.

For example, one or more parameters of a data burst associated with the data set may include a volume of the data burst including at least one of the following: the size of each PDU in the data burst, the number of PDU sets in the data burst, the volume of each PDU set in the data burst), combinations of the same, or the like.

For example, one or more redundancy parameters (e.g., Application Layer Forward Error Correction ratio (AL-FEC ratio) associated with the data set may be used to indicate the number of PDUs to decode for the PDU set. Further, for example, a data set may be a PDU set, in which the receiver may need to successfully receive at least K out of N PDUs in the PDU set to successfully decode the PDU set (e.g., a video frame at application layer). Moreover, for example, K or the ratio between K and N (e.g., K/N) may be used as one of the QoS and/or QoE parameters for the PDU set (e.g., to represent the redundancy parameter for the PDU set). Additionally, for example, a data set may be a PDU set, which may consist of multiple subsets of the PDU set. Also, for example, the WTRU may successfully transmit a ratio or a certain number of PDUs of each subset of the PDU set to satisfy a certain QoS and/or QoE requirement. Furthermore, for example, the ratio of each PDU may be used as one or more QoS and/or QoE parameters for the PDU set to represent the redundancy parameters for the PDU set.

In this disclosure, enhanced QoS rules are defined to include packet detection rules and/or packet filters set with intraflow and/or interflow dependencies (e.g., for WTRU packet classification and marking of UL data flows). For example, one or more QFIDs or packet filter sets may be specified as part of the QoS rules to capture dependent data flows such that dependent PDUs can be identified and grouped under one or more QIDs. Further, for example, intraflow dependencies may include relative packet importance criteria and/or identification as well as other packet characteristics affecting data treatment or prioritization within the flow. Moreover, for example, the QoS rules may include adaptable data treatment characteristics and associated target levels (e.g., associated with one or more QIDs). Even further, for example, a range or discrete values of PDB and/or bitrate may be specified for a particular data flow. Also, for example, the QoS rules may include conditional parameters, e.g., based on channel conditions or measurements, which define threshold values that may be used by the WTRU to dynamically change the QID (e.g., and associated data treatment of related data units). Additionally, for example, the QoS rules may be semi-statically configured or dynamically configured (e.g., based on conditional rules).

In some embodiments, data treatment of interdependent SDUs (e.g., and their corresponding PDUs) may be assigned a DTFID. For example, SDUs and/or PDUs with the same DTFID may be known to have associated data treatment characteristics (e.g., a shared synchronization window).

In the present disclosure, channel conditions may refer to any conditions relating to the state of a (e.g., radio) channel, which may be determined by the WTRU based on at least one of the following: a WTRU measurement (e.g., of layer 1 (L1), signal-to-interference-plus-noise ratio (SINR), reference signal received power (RSRP), channel quality indicator (CQI), modulation and coding scheme (MCS), channel occupancy, received signal strength indicator (RSSI), power headroom, exposure headroom, or the like); a layer 2 (L3) and/or mobility-based measurement (e.g., RSRP, reference signal received quality (RSRQ), s-measure, or the like); a radio link management (RLM) state; channel availability in an unlicensed spectrum (e.g., whether the channel is occupied based on a determination of a listen before talk (LBT) procedure or consistent LBT failure); combinations of the same; or the like.

In accordance with certain embodiments of the present disclosure, data unit QoS classification is described as follows. For example, the WTRU may assign a QID to each data unit within a RAN data flow, which determines the set of applicable QoS parameters with associated QoS target levels to characterize how the data should be transmitted. Further, for example, such characterization may represent constraints or requirements that the WTRU is expected to meet and/or enforce. Moreover, for example, the WTRU may perform different operations and/or adjust its behavior as a function of the state associated to the data (e.g., based on such characterization).

In accordance with certain embodiments of the present disclosure, dynamic QoS adaptation (e.g., performed by a WTRU) is described as follows for an SDU. However, the systems and methods in the present disclosure may apply equally to other data units (e.g., including PDUs, MAC-CEs, or the like).

In certain representative embodiments, the WTRU is configured with SDU treatment processing steps. In some embodiments, the WTRU is configured with SDU treatment processing steps for other forms of data units (e.g., PDUs, MAC-CEs, or the like). For example, the WTRU receives configuration information and/or indications on SDU treatment processing steps. In some embodiments, the WTRU receives information for supporting any of the procedures, mechanism, rules, and/or actions associated with at least one of the following: flow identification; selection of an applicable set of QoS parameters and/or applicable QID; association of intraflow dependencies, interflow dependencies, SDUs and/or PDUs; control of SDU treatment processing steps. Further, for example, the WTRU may receive configuration information and/or indications, via at least one of the following: RRC signaling and/or messages; control PDUs associated with any of the application support (AS) layers (e.g., SDAP control PDU, PDCP control PDU, RLC control PDU, or the like); DL MAC-CE; non-AS (NAS) layer signaling (e.g., a PDU session establishment response and/or a PDU session modification command); application layer signaling; combinations of the same; or the like.

For example, RRC signaling and/or messages may include dedicated and/or unicast signaling via any of signaling radio bearers (SRBs) or (e.g., broadcast) system information blocks (SIB). Further, for example, RRC messages may include at least one of RRC reconfiguration, RRC resume, or the like. Moreover, for example, RRC signaling may be used for configuring any criteria and/or parameter (e.g. threshold values, data types, ratio of K out of N data units, window sizes, or the like) associated with the selection of QoS parameter sets (e.g., QIDs), and/or determination of association between SDUs and/or PDUs. Also, for example, RRC signaling may be used for activating and/or deactivating (e.g., enabling and/or disabling) any of the procedures and/or criteria associated with the SDU treatment processing steps, e.g., including at least one of selection of a QID (e.g., corresponding to a QoS parameters set) or determining an association between SDUs and/or PDUs and/or associated DTFIDs.

For example, MAC-CE may be used for receiving info on SDU treatment processing steps, selecting QIDs (e.g., corresponding to QoS parameter sets), and/or determining associations between SDUs and/or PDUs. Further, for example, MAC-CE may be used for activating and/or deactivating preconfigured procedures and/or criteria associated with at least one of: the SDU treatment processing steps, selection of the QID, or determination of association between SDUs and/or PDUs.

In some embodiments, the information and/or indications associated with the selection of a QID, may include at least one of the following: an initial QID value, e.g., to associate with a data unit, SDU and/or PDU, data flow, or the like; a QID value associated with a QFID; a QID value associated with a DTFID; a QID value associated with a DRB; SDU and/or PDU information markings, e.g., information elements presented in an SDU and/or PDU header, e.g., a real-time transport protocol (RTP) header extension (HE), from which a QID value may be derived or informed; threshold values associated with the selection of QIDs; channel measurements (e.g., L1, SINR, RSRP, CQI, MCS, channel occupancy, RSSI, power headroom, exposure headroom, or the like) and associated thresholds; a QoE metric with associated QoE target level mapping to a QID; a QID value associated to a classification function or packet detection rule; combinations of the same; or the like.

For example, threshold values associated with the selection of QID may include at least one of the following: delay threshold values; reliability threshold values; flow bit rate threshold values; combinations of the same; or the like.

For example, delay threshold values may be associated with at least one of the following: delay bounds (e.g. PDB, PSDB, deadline, or the like); remaining time and/or delay values; synchronization delay values (e.g. time gap between SDUs and/or PDUs) associated with the transmission of any SDUs and/or PDUs in one or more flows; combinations of the same; or the like.

For example, reliability threshold values may be associated with at least one of the following: a minimum and/or maximum number of repetitions, duplicated transmissions, or retransmissions of the SDUs and/or PDUs; a minimum and/or maximum ratio of number of successfully transmitted SDUs and/or PDUs to the total transmitted SDUs and/or PDUs; combinations of the same; or the like. Further, for example, the WTRU may select a QID value if the reliability requirement (e.g. reliability ratio) associated with the SDU, PDU, and/or data flow is less than or equal to the reliability threshold associated with the QID value.

For example, the WTRU may select a QID value if the flow bit rate is less than or equal to a bitrate threshold value associated with the QID value. Additionally, for example, the WTRU may select a QID value if the flow bit rate is more than or equal to a bitrate threshold value associated with the QID value.

For example, the WTRU may be configured to change the QID value when the CQI and/or MCS is below or above a threshold.

For example, a classification function or packet detection rule may be based on IP 5-tuple or other characteristics of the SDU (e.g., IP packet) or based on SDU and/or PDU information markings (e.g., of PDUs of a PDU set).

In some embodiments, the information and/or indications associated with associations between SDUs and/or PDUs, may include at least one of the following: a flow identifier (e.g., QFID) for a flow, PDU set, bearer, or SDU; a classification function or packet detection rule; an indication from an application-level API; QoS parameters, e.g., synchronization window between flows, SDUs, PDUs, or the like; QoE dependency on system data, e.g., operator provided service, AI/ML data, sensing data, or the like; combinations of the same; or the like. For example, a data flow may be dependent on system data (e.g., AI/ML data) and the WTRU may assign the proper QID based on the dependency.

In certain representative embodiments, the WTRU determines the association between SDUs and/or PDUs. In some embodiments, the WTRU determines an association between other forms of data units (e.g., MAC-CEs, or the like). For example, the WTRU may determine the association between the SDUs and/or PDUs (e.g., and/or PDU set) and associates a DTFID value to each data unit based on at least one of the following: a flow identifier (e.g., QFID) of the SDU; a classification function; an indication from an application-level API; QoS parameters; QoE dependency on system data; combinations of the same; or the like.

For example, the WTRU may determine the DTFID based on the QFID. Further, for example, the WTRU may assign a single DTFID to one or more QFIDs.

For example, a classification function may be based on IP 5-tuple, other characteristics of the SDU (e.g., IP packet), and/or SDU information markings. Further, for example, the SDU may contain a data type information marking that is then associated with a DTFID value (e.g., by the WTRU). Also, for example, more than one 5-tuple may be associated with a single DTFID value.

For example, the application may indicate interdependent data flows based on IP 5-tuple. Further, for example, the WTRU may determine the association of the interdependent data flows and assign a DFTID value to represent the association.

For example, the WTRU may determine the association and associate a DTFID value based on QoS parameters including a synchronization window between flows, SDUs, and/or PDUs. Further, for example, the WTRU may associate SDUs corresponding to one or more QFID with the same synchronization window (e.g., and assign a common DTFID).

For example, the WTRU may determine the association and associate a DTFID value based on QoE dependency on system data (e.g., operator provided service, AI/ML data, sensing data, or the like.). Further, for example, a data flow marked with a QFID may be dependent on system data (e.g., AI/ML data) and the WTRU may assign a DTFID to both the QFID and to the dependent system data PDUs and/or data flow.

In certain representative embodiments, the WTRU determines an applicable set of QoS parameters, e.g., for an SDU. In some embodiments, the WTRU determines an applicable set of QoS parameters for other data units (e.g., PDUs, MAC-CEs, or the like).

For example, the WTRU may determines a set of QoS parameters to apply (e.g., a QID value) for an SDU and/or PDU and/or PDU set, one or more data flows, or a radio bearer based on at least one of the following: an indication from a higher layer received by the WTRU (e.g., including a QID value to apply and a DTFID and/or QFID to which the QID value is applicable); an indication from application-level API received by the WTRU; SDU, PDU, or PDU set information markings; channel measurements; QoS measurements associated with the data flow; a condition and/or one or more threshold values; control information received from the wireless network; combinations of the same; or the like.

For example, the indication from the application-level API may include a flow identification (e.g., QFID) with a corresponding QID value or similar QoS target level value to apply to the identified flow. Further, for example, the indication may contain a QFID along with a QoS target level qualifier (e.g., UP, DOWN, or STABLE), and the WTRU may apply an associated QID value to the QFID. Moreover, for example, the indication may contain a QFID with a relative QoS target level (e.g., +1, −1) and the WTRU may apply an associated QID value relative to a (e.g., current, default) QID value.

For example, a QID value may be present in the PDU information markings. Further, for example, a QoS target level value is included in the information marking, which is associated to a QID value. Moreover, for example, a set of PDU information markings (e.g., PDU importance, PDU error rate, PDU delay budget) may be associated to a QID value. Furthermore, for example, the WTRU may extract QoS and/or QoE target level information from the transport protocol header (e.g., an RTP HE QoS and/or QoE metric/level information element (IE)), which is then associated to a QID value through configured mapping. Additionally, for example, the WTRU may be informed of QoS and/or QoE level information via a transport control protocol (e.g., an RTCP control message which is then associated to a QID value through configured mapping).

For example, the WTRU may determine a set of QoS parameters to apply based on measuring a channel condition below or above a given threshold or measuring a change in the channel conditions below or above a given threshold. Further, for example, the QID value may be selected relative to a (e.g., current, default) QID value or be determined based on crossing a measurement threshold.

For example, the WTRU may determine a set of QoS parameters to apply based on QoS measurements associated with the data flow. Further, for example, a measured QoS (e.g., including bitrate, latency) may indicate whether the QoS is met or not met and may be used to assign QID.

For example, the WTRU may determine a set of QoS parameters to apply based on a condition and/or one or more threshold values. Further, for example, threshold values may include delay threshold values and reliability threshold values. Also, for example, delay threshold values may be associated with delay bounds (e.g. PDB, PSDB, deadline, or the like), remaining time and/or delay values, and synchronization delay values (e.g. time gap between SDUs and/or PDUs) associated with the transmission of any SDUs and/or PDUs in one or more flows.

For example, reliability threshold values may be associated with at least one of: a minimum and/or maximum number of repetitions, duplicated transmissions, or retransmissions of the SDUs and/or PDUs; a minimum and/or maximum ratio of number of successfully transmitted SDUs and/or PDUs to the total transmitted SDUs and/or PDUs; combinations of the same; or the like. Additionally, for example, the WTRU may select a QID value when the reliability requirement (e.g. reliability ratio) associated with the SDU, PDU, and/or data flow is less than or equal to the reliability threshold associated with the QID value.

For example, the WTRU may determine a set of QoS parameters to apply based on control information received from the wireless network (e.g., via MAC-CE). Further, for example, the WTRU may receive updated QID assignment based on specific packet detection rules.

In certain representative embodiments, the WTRU performs SDU treatment processing. In some embodiments, treatment processing is performed on other forms of data units (e.g., PDUs, MAC-CEs, or the like). For example, the WTRU may perform SDU treatment processing steps based on the received configuration information. Further, for example, the SDU processing steps may include at least one of the following: data unit association determination; selection of a set of QoS parameters; application of selected DTFID and/or QID to the SDU and/or PDU; notification of the selected DTFID and/or QID; combinations of the same; or the like.

In some embodiments, the WTRU determines a data unit association identifying data unit relationships by selecting a DFTID based on configured triggers. For example, the WTRU may be configured to associate data flows marked with QFIDs by assigning a DFTID.

In some embodiments, the WTRU selects a set of QoS parameters via a QID based on configured triggers. For example, the WTRU may be configured to select a QID based on the QFID and/or DTFID associated with a data flow.

In some embodiments, the WTRU applies the selected DTFID and/or QID to the SDU and/or PDU. For example, the WTRU may apply the DFTID and/or QID as part of the SDUs and/or PDUs header information for differentiated data unit treatment based on DFTID and/or QID. Further, for example, the WTRU may use specific data unit queuing strategies and/or queues based on the selected DTFID and/or QID.

In some embodiments, the WTRU notifies the wireless network about the selected DTFID and/or QID. For example, the WTRU may be configured to notify the wireless network about a change in UL QID selection for a given QFID and/or DTFID. Further, for example, the notification may enable the wireless network to adapt the associated resource allocation according to the set of QoS parameters associated with the QID.

In some embodiments, the WTRU performs the SDU treatment processing steps as part of the SDAP layer. In some embodiments, the WTRU performs the SDU treatment processing steps as part of other L2 protocol layers (e.g., PDCP, RLC, MAC) or a newly defined protocol layer. For example, incoming SDUs may be assigned a QFID based on a configured IP 5-tuple. Further, for example, there may be more than one data flow for which SDUs are assigned a QFID. Moreover, for example, dependent QFIDs may be used to associate a DTFID. Additionally, for example, a DTFID may be used to select and/or apply a QID which will determine the applicable QoS parameters and associated target levels. Also, for example, the QID may be carried in the SDAP header and/or onto lower layers to indicate the data treatment to apply to the SDUs and/or associated PDUs. Even further, for example, the application may decide to change the UL bitrate of a video stream in response to a request from a spatial computing server. In addition, for example, the application may carry the change of bitrate as part of the SDU information markings (e.g., RTP HE to inform about a QoE bitrate target level). Furthermore, for example, upon reaching the WTRU, the SDU treatment processing steps may become aware of the change in UL bitrate requirements based on the RTP HE QoE target level. Likewise, for example, this information (e.g., the change in UL bitrate requirements) may be used by the SDU treatment processing to select an appropriate QID value and dynamically apply a new set of QoS parameters via the QID. Also, for example, the QID update may be signaled to the wireless network to adjust the resource allocation.

FIG. 2 is a flowchart of an illustrative method performed by a WTRU for dynamic QoS adaptation, in accordance with certain embodiments of the present disclosure.

In certain representative embodiments, as shown in FIG. 2, a process 200 is performed by a WTRU (e.g., 102 of FIGS. 1A-D) in connection with a wireless network (e.g., RAN 104 and 113 of FIGS. 1A-D), which may be implemented in a communication system such as a communications system 100 illustrated in FIG. 1A-1D.

At step 202, the WTRU stores configuration information (e.g., received from a wireless network) indicating a plurality of QIDs, wherein each QID is associated with a set of QoS parameters. For example, QoS parameters may include at least one of the following: MFBR, AMBR, MDBV, maximum packet loss rate, PDB, PER, priority level, PDU set QoS parameters, combinations of the same, or the like.

At step 204, the WTRU receives a data unit, e.g., from the wireless network. For example, the data unit may include at least one of: SDU, PDU, PDU set, MAC-CE, combinations of the same, or the like.

At step 206, the WTRU selects a QID of the plurality of QIDs for the data unit, wherein the selecting includes one of: associating a DTFID to the data unit (e.g., based on data unit dependencies) and selecting the QID of the plurality of QIDs for the data unit based on the associated DTFID; identifying a QFID corresponding to the data unit and selecting the QID of the plurality of QIDs for the data unit based on the identified QFID; combinations of the same; or the like. In some embodiments, selecting the QID includes associating the DTFID to the data unit and selecting the QID of the plurality of QIDs based on the associated DTFID. For example, the associating the DTFID to the data unit may include at least one of the following: identifying a QFID corresponding to the data unit; performing classification of the data unit based on a classification function; or identifying an information marking of a protocol data unit (PDU) corresponding to the data unit; combinations of the same; or the like. Further, for example, the WTRU may associate the DTFID to the data unit based on a trigger and/or condition (e.g., channel conditions or measurements). In some embodiments, the WTRU receiving the data unit includes receiving a plurality of data units and the WTRU associating the DTFID to the data unit includes associating the DTFID to interdependent data units of the plurality of data units. In some embodiments, the set of QoS parameters associated with the selected QID include at least one of the following: a synchronization window, a reliability requirement, a traffic type, periodicity, combinations of the same, or the like. In some embodiments, the selecting the QID of the plurality of QIDs for the data unit based on the identified QFID includes receiving an indication from a higher layer or application programming interface of a target QID for the identified QFID and selecting the QID of the plurality of QIDs based on the target QID. In some embodiments, the target QID includes a relative target QID, and selecting the QID of the plurality of QIDs based on the target QID includes identifying a current QID for the identified QFID and selecting the QID of the plurality of QIDs based on adjusting the current QID by the relative target QID. At step 208, the WTRU transmits, to the wireless network, the data unit based on the set of QoS parameters associated with the selected QID. In some embodiments, the WTRU may also notify the wireless network of the selected QID and/or the associated DTFID (e.g., corresponding to one or more QFIDs). In some embodiments, the transmitting the data unit based on the set of QoS parameters associated with the selected QID includes transmitting, to the wireless network, an indication of the selected QID.

In some embodiments, a WTRU (e.g., 102 of FIGS. 1A-D) is configured to perform any combination of the above-referenced steps of the method 200.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

What is claimed is:

1. A method performed by a wireless transmit/receive unit (WTRU) in connection with a wireless network, the method comprising:
storing configuration information indicating a plurality of quality of service index values (QIDs), wherein each QID is associated with a set of quality of service (QoS) parameters;
receiving a data unit;
selecting a QID of the plurality of QIDs for the data unit, wherein selecting the QID includes one of:
(a) associating a data treatment flow identification (DTFID) to the data unit and selecting the QID of the plurality of QIDs for the data unit based on the associated DTFID; or
(b) identifying a data flow identifier (QFID) corresponding to the data unit and selecting the QID of the plurality of QIDs for the data unit based on the identified QFID; and
transmitting, to the wireless network, the data unit based on the set of QoS parameters associated with the selected QID.

2. The method of claim 1, wherein selecting the QID includes:
associating the DTFID to the data unit; and
selecting the QID of the plurality of QIDs based on the associated DTFID.

3. The method of claim 2, wherein associating the DTFID to the data unit includes one of:
identifying a QFID corresponding to the data unit;
performing classification of the data unit based on a classification function; or
identifying an information marking of a protocol data unit (PDU) corresponding to the data unit.

4. The method of claim 2, wherein:
receiving the data unit includes receiving a plurality of data units; and
associating the DTFID to the data unit includes associating the DTFID to interdependent data units of the plurality of data units.

5. The method of claim 1, wherein the set of QoS parameters associated with the selected QID includes at least one of a synchronization window, a reliability requirement, traffic type, or periodicity.

6. The method of claim 1, wherein selecting the QID includes:
identifying the QFID corresponding to the data unit; and
selecting the QID of the plurality of QIDs for the data unit based on the identified QFID.

7. The method of claim 6, wherein selecting the QID of the plurality of QIDs for the data unit based on the identified QFID includes:
receiving an indication from a higher layer or application programming interface of a target QID for the identified QFID; and
selecting the QID of the plurality of QIDs based on the target QID.

8. The method of claim 7, wherein the target QID includes a relative target QID, and selecting the QID of the plurality of QIDs based on the target QID includes:
identifying a current QID for the identified QFID; and
selecting the QID of the plurality of QIDs based on adjusting the current QID by the relative target QID.

9. The method of claim 1, wherein transmitting the data unit based on the set of QoS parameters associated with the selected QID includes:
transmitting, to the wireless network, an indication of the selected QID.

10. The method of claim 1, wherein transmitting the data unit based on the set of QoS parameters associated with the selected QID includes:
applying the set of QoS parameters associated with the selected QID to a service data unit (SDU) or a protocol data unit (PDU) corresponding to the data unit; and
transmitting the SDU or PDU based on the set of QoS parameters associated with the selected QID.

11. A wireless transmit/receive unit (WTRU) comprising:
a processor; and
a transceiver, wherein the WTRU is configured to:
store configuration information indicating a plurality of quality of service index values (QIDs), wherein each QID is associated with a set of quality of service (QoS) parameters;
receive a data unit;
select a QID of the plurality of QIDs for the data unit, wherein the WTRU is configured to select the QID by one of:
(a) associating a data treatment flow identification (DTFID) to the data unit and selecting the QID of the plurality of QIDs for the data unit based on the associated DTFID; or
(b) identifying a data flow identifier (QFID) corresponding to the data unit and selecting the QID of the plurality of QIDs for the data unit based on the identified QFID; and
transmit, to the wireless network, the data unit based on the set of QoS parameters associated with the selected QID.

12. The WTRU of claim 11, wherein the WTRU is configured to select the QID by:
associating the DTFID to the data unit; and
selecting the QID of the plurality of QIDs based on the associated DTFID.

13. The WTRU of claim 12, wherein the WTRU is configured to associate the DTFID to the data unit by:
identifying a QFID corresponding to the data unit;
performing classification of the data unit based on a classification function; or
identifying an information marking of a protocol data unit (PDU) corresponding to the data unit.

14. The WTRU of claim 12, wherein the WTRU is configured to:
receive the data unit by receiving a plurality of data units; and
associate the DTFID to the data unit by associating the DTFID to interdependent data units of the plurality of data units.

15. The WTRU of claim 11, wherein the set of QoS parameters associated with the selected QID includes at least one of a synchronization window, a reliability requirement, traffic type, or periodicity.

16. The WTRU of claim 11, wherein the WTRU is configured to select the QID by:
identifying the QFID corresponding to the data unit; and
selecting the QID of the plurality of QIDs for the data unit based on the identified QFID.

17. The WTRU of claim 16, wherein the WTRU is configured to select the QID of the plurality of QIDs for the data unit based on the identified QFID by:
receiving an indication from a higher layer or application programming interface of a target QID for the identified QFID; and
selecting the QID of the plurality of QIDs based on the target QID.

18. The WTRU of claim 17, wherein the target QID includes a relative target QID, and the WTRU is configured to select the QID of the plurality of QIDs based on the target QID by:
identifying a current QID for the identified QFID; and
selecting the QID of the plurality of QIDs based on adjusting the current QID by the relative target QID.

19. The WTRU of claim 11, wherein the WTRU is configured to transmit the data unit based on the set of QoS parameters associated with the selected QID by:
transmitting, to the wireless network, an indication of the selected QID.

20. The WTRU of claim 11, wherein the WTRU is configured to transmit the data unit based on the set of QoS parameters associated with the selected QID by:
applying the set of QoS parameters associated with the selected QID to a service data unit (SDU) or a protocol data unit (PDU) corresponding to the data unit; and
transmitting the SDU or PDU based on the set of QoS parameters associated with the selected QID.
